(19) United States
(12) Patent Application Publication
(10) Pub. No.: US 2026/0225245 A1
(43) Pub. Date: Aug. 6, 2026

(54) FUNCTIONAL SAFETY SYSTEM FOR ROBOTS

(71) Applicant: Dexterity, Inc., Redwood City, CA (US)

(72) Inventors: Gil Matzliach, Sunnyvale, CA (US); Zhouwen Sun, San Mateo, CA (US); Keshav Prasad, Saratoga, CA (US); Samir Menon, Atherton, CA (US)

(21) Appl. No.: 19/400,130

(22) Filed: Nov. 25, 2025

Related U.S. Application Data
(60) Provisional application No. 63/724,659, filed on Nov. 25, 2024.

(51) Int. Cl. B25J 9/16; B25J 5/00; B25J 19/06

(52) U.S. Cl. CPC B25J 9/1676; B25J 5/007; B25J 9/1694; B25J 19/06

(57) ABSTRACT

A functional safety system for robots is disclosed. In various embodiments, sensor data is received from one or more sensors. The sensor data is used to detect, in or near a workspace in which a robot with which the robotic safety system is associated is located, an actor or instrumentality that poses a potential safety risk to one or both of the robot and the detected actor or instrumentality. A safety posture of the robotic safety system with respect to the robot is adapted to an extent needed to ensure the continued safety of both the robot and the detected actor or instrumentality. The adapted safety posture takes into account one or more of a task of the robot and a position and velocity of the actor or instrumentality relative to the robot.

### CROSS REFERENCE TO OTHER APPLICATIONS

This application claims priority to U.S. Provisional Patent Application No. 63/724,659 entitled FUNCTIONAL SAFETY SYSTEM FOR ROBOTS filed November 25, 2024, which is incorporated herein by reference for all purposes.

### BACKGROUND OF THE INVENTION

Typically, robotic systems are installed in a static location, such as a fixed workstation. Human safety typically is protected by measures such as using physical barriers to keep humans separate from robots, using warning lights or other techniques to warn humans if a robot is being used in a way that could harm them if they were to approach, and using detection systems, such as sensors that provide an indication when a gate or other access structure is opened and/or light curtains or other sensors or arrays of sensors to detect that a barrier around the robot has been crossed.

Other robots may move within a work area, but in controlled ways along established paths, which makes it possible to protect humans by excluding them from areas through which the robot might pass.

In typical prior approaches, the sensors and other equipment used to detect that an area in which a robot is working has been entered have been fixed structures that only work in situations in which the robot works in a defined area from which others can be excluded, at least while the robot is working. In modern business logistics settings, for example, and other industrial and commercial settings, robots increasing are used to perform a range of tasks, some of which may require them to move between locations in a facility in which humans also work and/or to work closely in cooperation with humans.

Further, typical prior systems have been able to detect that a defined space within a robot is working has or potentially has been entered, but such systems typically don’t know whether the space has been entered or merely left accessible and/or to determine if a subject in proximity to a robot is a person or non-person, such as another robot.

### BRIEF DESCRIPTION OF THE DRAWINGS

Various embodiments of the invention are disclosed in the following detailed description and the accompanying drawings.

FIG. 1 illustrates an embodiment of a robotic system comprising a functional safety system.

FIG. 2 illustrates an embodiment of a mobile robot having cameras and/or other sensors mounted on a pole attached to its mobile chassis.

FIG. 3 is a state diagram that illustrates operation of a functional safety system as disclosed herein, in various embodiments.

FIG. 4 is a state diagram that illustrates operation of a functional safety system as disclosed herein, in various embodiments.

FIG. 5 is a flow chart illustrating an embodiment of a process to use data from sensors not mounted on the robot to perform functional safety processing as disclosed herein.

FIG. 6 illustrates a situation in which a robot and a human worker are at risk of colliding as each approaches a corner initially unaware of the presence and approach of the other.

FIG. 7 illustrates an embodiment equipped with a functional safety system as disclosed herein.

FIG. 8 illustrates an embodiment equipped with a functional safety system as disclosed herein.

FIG. 9 illustrates an embodiment equipped with a functional safety system as disclosed herein.

FIG. 10 illustrates an embodiment equipped with a functional safety system as disclosed herein.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description to provide a thorough understanding of the invention. These details are provided for the purpose of example and the invention may be practiced according to the claims without some or all these specific details. For clarity, technical material that is known in the technical fields related to the invention has not been described in detail so that the invention is not unnecessarily obscured.

A functional safety system for robotics is disclosed. In various embodiments, a functional safety system as disclosed herein may be implemented, as a whole or in part, as a subsystem, module, and/or component of a robotic control system. In some embodiments, the functional safety system and/or the robotic control system of which it is a component part is implemented on a mobile robot, such as an autonomous mobile robot (AMR).

In various embodiments, a functional safety system as disclosed herein uses a plurality of sensors and/or other inputs to ensure, in a manner adapted dynamically to changes in how the robot is operating and the context in which it is operating, that no human is harmed by the robot and/or that the robot is not damaged. In some embodiments, a robot equipped and/or configured as disclosed herein will stop operating, e.g., perform an emergency stop (“e-stop”), unless all sensors, algorithms, heuristics, etc. are consistent with no human being present in a dynamically adapted danger zone in proximity to the robot.

In some embodiments, a robot equipped and/or configured as disclosed herein may adjust its behavior, plan, etc., as a human subject gets nearer to the robot. For example, a robot as disclosed herein may slow down in stages as a human subject gets nearer, to better be able to stop quickly if a human enters the danger zone. Or a mobile robot that is on the move to a destination may reduce its speed and/or re-route itself to avoid coming too close to the human. In another example, a robot as disclosed herein may pay closer attention to a human subject as the distance to the subject decreases, such as by increasing a rate of sensing or sampling sensor output, decreasing the interval between updates to its behavior based on the approach of the human subject and other considerations, etc. In some embodiments, the robot may provide visual or audio warnings such as flashing lights or a voice command to “remain clear of the area”.

In some embodiments, the robot may adjust an impedance, stiffness, or other setting that affects how the robot responds to an external force, such as may be associated with colliding with a human, another robot, a component of its, or an obstacle. For example, the robot may become more compliant and may respond with limited speed, force, torque, etc. to ensure the robot does not harm or damage itself or the source of the external force.

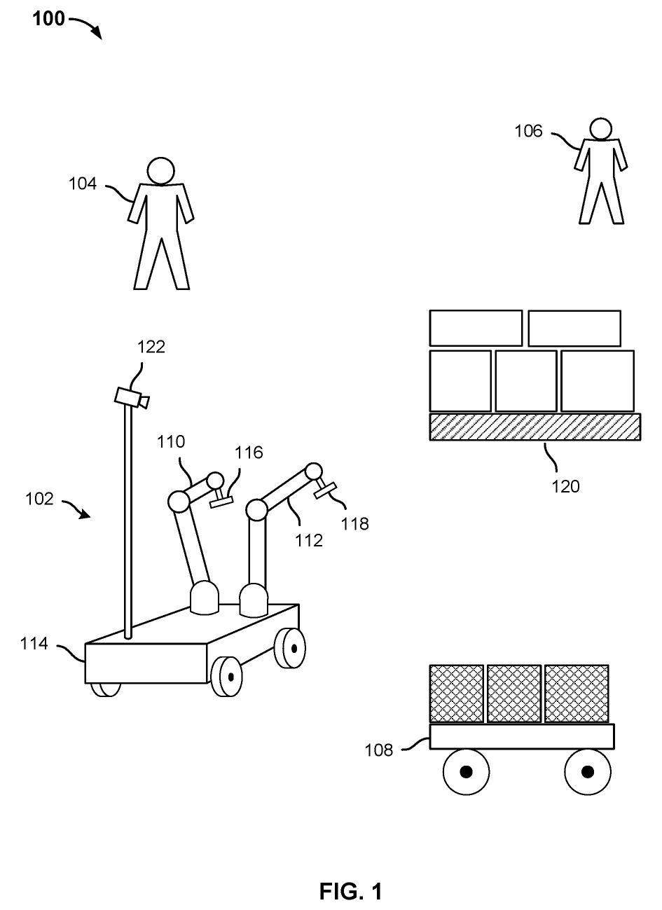

FIG. 1 illustrates an embodiment of a robotic system comprising a functional safety system. In the example shown, system and environment 100 includes an autonomous mobile robot (AMR) 102 comprising a functional safety system, as disclosed herein, which operates in a logistics setting, e.g., a warehouse or shipping center, in which human workers 104, 106 and other robots, such as an automated guided vehicle (AGV) 108 also are present and active. In this example, the AMR includes two robotic arms 110, 112 mounted on a robotically controlled mobile base 114. While in the example shown in FIG. 1 the mobile base 114 has wheels, in other embodiments the mobile base 114 may comprise legs, treads, or other elements to provide locomotion. The AMR 102 uses its two robotic arms 110, 112, and their respective end effectors 116, 118 (e.g., grippers, suction) to pick/place boxes or other objects. For example, in the scene as shown the AMR 102 may pick items from the AGV 108 and stack them on the pallet 120, or vice versa. As shown, human workers 104, 106 in the same workspace 100 are safe so long as there is adequate distance between them and the AMR 102.

In various embodiments, to keep humans 104, 106 safe, the AMR/robot 102 adapts its behavior based on factors such as its own current and planned operations, the location of the humans, and the relative, anticipated, and/or planned motion of each. For example, if humans 104, 106 are sufficiently far away, not moving nearer, and the AMR 102 is working in a relatively well-defined area, the AMR 102 may operate relatively more freely than in other circumstances. By contrast, if humans 104, 106 are near and/or approaching, or if the robot 102 is in transit and needs to pass through an area in which a human 104, 106 is present, the functional safety system may cause the robot 102 to adapt its behavior, such as by slowing down (or stopping), changing its route, or reordering a sequence of operations to put off an operation or task that would or may bring the robot 102 into closer proximity to a human 104, 106.

In various embodiments, a functional safety system as disclosed herein may use knowledge, predictions, observations, etc. of the capabilities, habits, attributes and past behaviors, etc. of an autonomous actor (e.g., human, other robot) determined to be present in the workspace in which the robot with which the functional safety system is operating to develop and implement an adaptive safety plan and/or action with respect to each such actor.

In some embodiments, artificial intelligence systems, tools, and/or techniques may be used to predict the future movement or other behavior of a human, robot, or other actor or instrumentality detected to be present in or approach the workspace in which a robot is operating and/or through which the robot is transiting. A safety posture may be adapted based on such a prediction. If the prediction proves wrong, the functional safety system may adapt the safety posture further, based on observed behavior that deviates from the predicted behavior. In the extreme case, i.e., imminent threat of harm to a human, the system may perform and emergency stop.

In various embodiments, the functional safety system adapts its safety posture, policies, and behaviors as/if needed to protect the robot with which the functional safety system is associated and the other actor(s) from harm.

For example, in the case of a human interloper, a functional safety system as disclosed herein may determine the current location and velocity (speed and direction) of the human and may make an adaptive plan based at least in part what it knows about this human or humans in general, e.g., they only go so fast (max speed) and have limited acceleration (rate of change of speed), and their limbs only extend so far out. More specifically, the function safety system may recognize the human and the context. For example, the system may predict based on prior observations that the human will approach the robot but stop outside a known range of the robot, perform a task, then walk away. Based on the prediction, the system may allow the robot to continue to operate but may implement more frequent or focused observation of the human as they approach. If the prediction proves wrong and the human comes closer than expected, the system may restrict operation of the robot or, if needed, perform an emergency stop.

In various embodiments, a functional safety system as disclosed herein may use image, sound, LIDAR, or other sensor data generated by sensors mounted on the robot, e.g., pole-mounted camera 122 in the example shown in FIG. 1, or an associated (e.g., attached structure) and/or sensors mounted in fixed locations in the workspace.

While in the example shown in FIG. 1 and in other examples below an autonomous mobile robot 102 having a wheel-based drivetrain is shown, in various embodiments techniques disclosed herein may be applied to AMR’s with other drive trains (e.g., tracts, legs, etc.) or to a stationary robot.

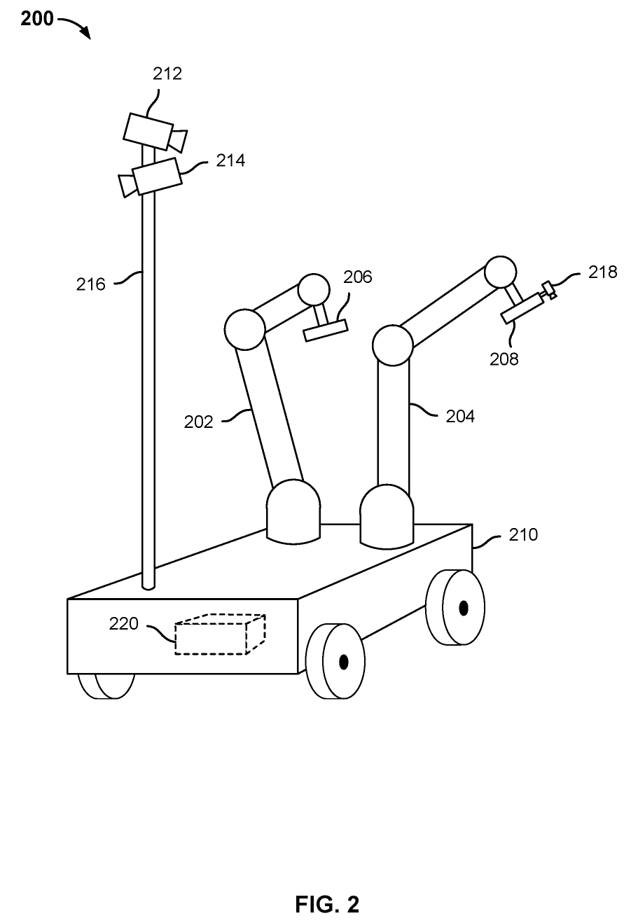

FIG. 2 illustrates an embodiment of a mobile robot having cameras and/or other sensors mounted on a pole attached to its mobile chassis. In the example shown, mobile robot 200 includes robotic arms 202, 204 having associated end effectors 206, 208, respectively, mounted on a robotically controlled mobile chassis 210.

Cameras (or other sensors) 212, 214 mounted on pole 216 and camera 218 mounted on robotic arm 204 to the side of end effector 208 are used, in various embodiments of a functional safety system as disclosed herein, to maintain a three-dimensional view of at least critically relevant portions of a workspace in which robot 200 is operating. In various embodiments, a computer vision module comprising an onboard (or remote) control computer 220 may be configured to receive and process image data including by performing segmentation and human recognition processing to detect the presence and location of a human in the field of view. In various embodiments, a camera or other sensor may be mounted on a robotic arm, telescoping pole, or other movable structure comprising and/or attached to the robot.

While in the example shown in FIG. 2 computer vision or other sensor processing may be performed by onboard control computer 220 housed within mobile chassis 210, in other embodiments all or part of such processing may be performed by a control computer not housed on or in robot 200 and which may even be located at a remote location.

In some embodiments, sensors of multiple types capable of being used to detect the presence of a human are used. If some embodiments, if any sensor and/or component configured to detect the presence of a human based on sensor data detects a possible human, the robot stops operating until all sensors and/or components agree that no human is present.

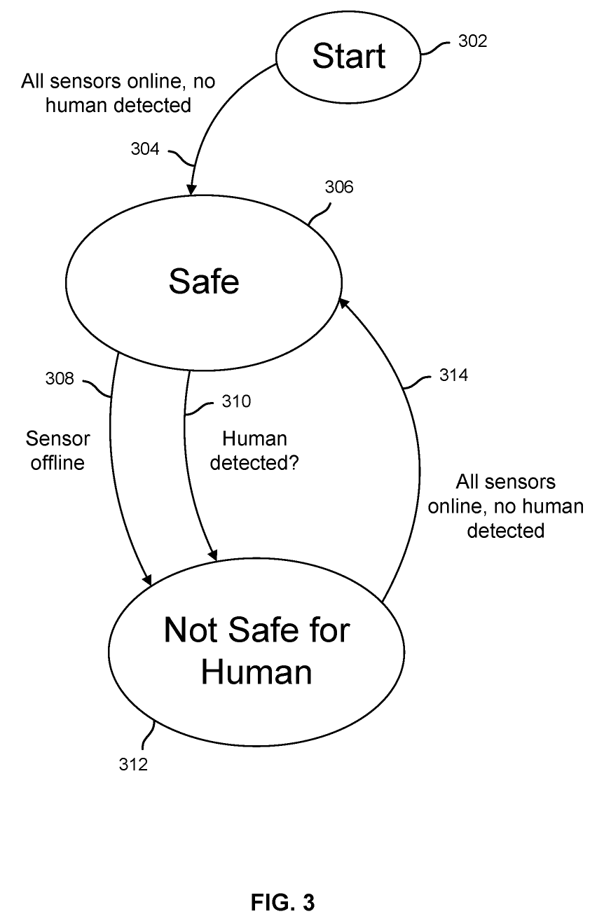

FIG. 3 is a state diagram that illustrates operation of a functional safety system as disclosed herein, in various embodiments. In the example shown, on system startup 302 a check is performed to ensure that all sensors are online and that no human is detected by any sensor or component. If so, the robot enters 304 a “safe” operating mode of operation 306 in which the robot operates relatively freely. If any sensor or component used to detect the presence of a human goes offline 308 or if any sensor or component detects that a human may be present or approaching 310, the system transitions to a “not human safe” state 312 in which appropriate responsive action, e.g., adjusting behavior, changing route or otherwise changing plan, stopping operation, emergency stop, etc. is performed. Once all sensors and components used to detect human presence are (again) online and currently indicating no human presence 314, the system transitions back to the “safe” state 306.

In the example shown in FIG. 3, the system is in one of two states, i.e., “safe” 306 or “not safe” 312. In various embodiments, a robot as disclosed herein may be configured to adapt its behavior more granularly, based on factors such as how close the human is, whether and how fast the robot is moving, etc.

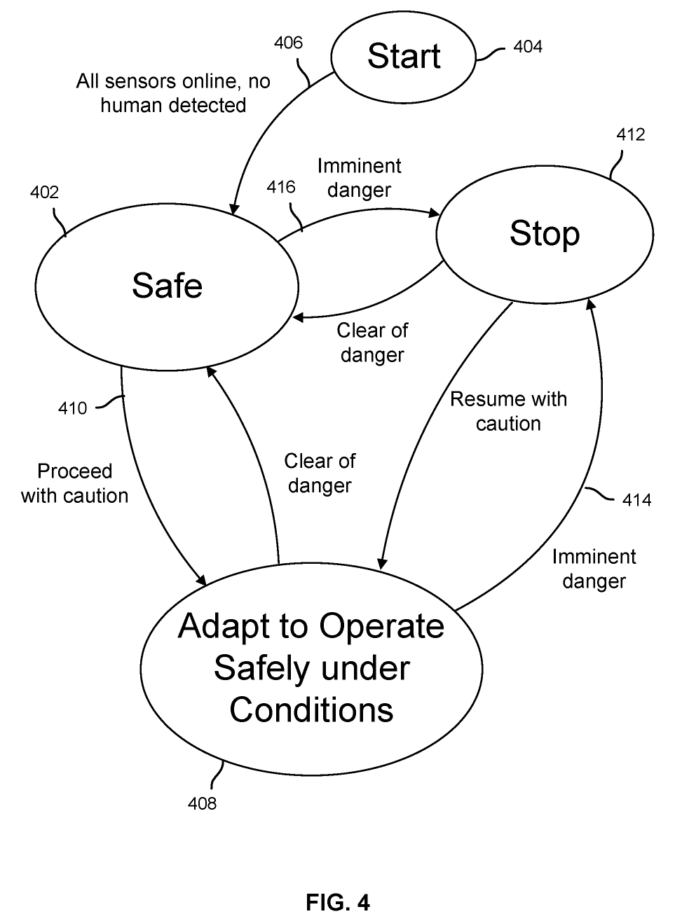

FIG. 4 is a state diagram that illustrates operation of a functional safety system as disclosed herein, in various embodiments. In the example shown in FIG. 4, the robot may transition between three or more states, including in the example shown a “safe” state 402 (all sensors online, no human detected 404, 406), an “adapt” state 408, 410 (human detected at a safe distance, or human proximity predicted at a distant future point in time, for example), or a “stop” state 412 (unacceptable risk to a human would exist unless the robot stopped immediately, e.g., e-stop 414, 416). In some embodiments, multiple “adapt” states, each having increasingly stringent restrictions to protect human safety, may exist.

In various embodiments, a mobile robot includes a functional safety system, module, or component as disclosed herein. Data from sensors mounted on the robot and/or in the workspace may be integrated and used to detect humans and dynamically adapt behavior to ensure human safety, as disclosed herein.

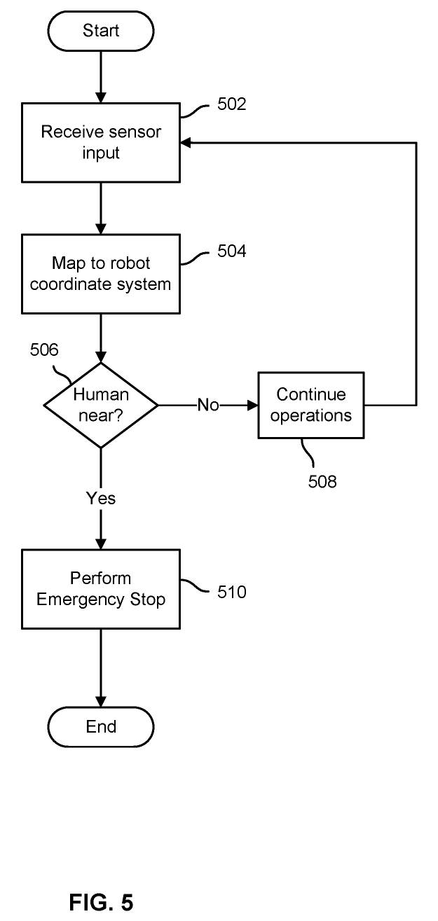

FIG. 5 is a flow chart illustrating an embodiment of a process to use data from sensors not mounted on the robot to perform functional safety processing as disclosed herein. For example, cameras and other sensors on a mobile robot may be used in connection with cameras and/or other sensors mounted in the workspace to determine or anticipate the presence or not of humans near the robot. In various embodiments, the process of FIG. 5 may be performed by a control computer on the robot, e.g., control computer 220 of FIG. 2, and/or may be performed wholly/partly by a computer not on the robot.

In the example shown in FIG. 5, sensor data is received at 502 and mapped at 504 to the robot-centric coordinate system, which may be moving (translating in the X-Y plane) and/or rotating (e.g., about its Z axis) if the robot is in moving its chassis to perform work or is in transit between locations. Sensor data from sensors in the workspace that has been mapped to the robot coordinate system may be integrated with data from sensors on the robot and all used to detect whether a human is (or may be) present. If all sensors, components, etc. agree that no human is present, operations continue 508. If a human (or possible human presence) is detected, an emergency stop (or, in some embodiments, an adaptive change in behavior) is performed.

In various embodiments, sensors and human presence detection components of a variety of types may be used to detect and/or verify the presence or non-presence of a human, determine the location and/or distance to a human, compute the speed (velocity) of a human, in absolute terms or relative to current and/or planned robot motion, etc. In some embodiments, cameras or other image sensors may be used to detect a face or other human feature. Depth pixels and/or point clouds generated by 3D cameras and/or LIDAR or other range sensors may be used to determine more and/or adequately precisely the distance to a detected human. Biometric sensors may be used, e.g., in addition to image data, such as single-channel continuous wave (CW) radar or other sensors to detect presence/proximity of a human heartbeat, audio sensors and processing components to detect a human voice and/or distinguish a human voice and/or approaching footsteps from other sounds that may be present in a workspace, etc.

A logistics or other commercial workspace may present challenges to human detection. For example, a sensor’s field of view may be blocked by a robot, their arm or other element, obstacles in and features of the workspace, etc. One challenge is the need to avoid colliding with a human as a robot approaches or rounds a blind corner or other obstacle.

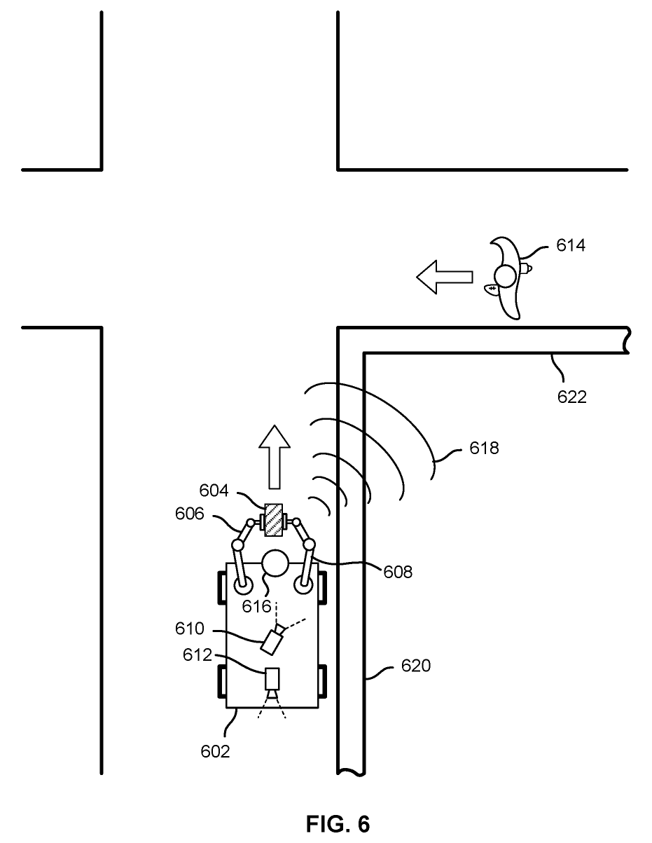

FIG. 6 illustrates a situation in which a robot and a human worker are at risk of colliding as each approaches a corner initially unaware of the presence and approach of the other. In the example shown, a mobile robot 602 approaches the corner with a box 604 held between the end effectors of its robotic arms 606, 608. The robot is equipped with forward and rear facing cameras 610, 612, but the corner obscures the view of the forward-facing camera so that the approaching human 614 is not in its optical field of view. In the example shown, an active (or passive) sensor 616 of the robot, other than the forward-looking camera 610 is used to detect the approach of the human. For example, single-channel continuous wave (CW) radar 618 or other sensors may be used to detect a heartbeat, for example, even through the walls 620, 622 defining the corner and/or audio sensors may be used to detect a human voice and/or footsteps.

In some embodiments, the robot may know (e.g., by configuration) or sense that it is approaching the corner, and may use a robotic arm, telescoping pole, or other robotically controlled structure to extend a camera to peer around the corner, e.g., as the robot slowly approaches or stops just short of the corner. If no human is detected by any sensor/component, the robot resumes or continues its transit.

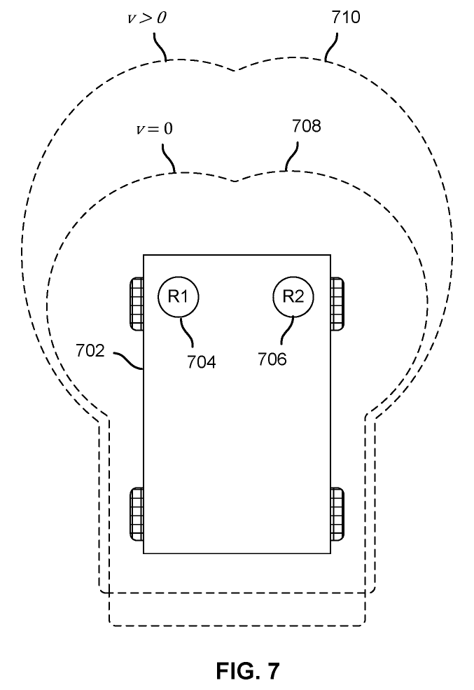

FIGS. 7 through 10 illustrate ways in which a robot equipped with a functional safety system as disclosed herein may adapt its behavior and/or safety protocols based on what the robot is doing at a given time, in various embodiments.

FIG. 7 illustrates an embodiment equipped with a functional safety system as disclosed herein. In the example shown, a functional safety system comprising robot 702 having robotic arms “R1” 704 and “R2” 706 implements adaptive safety zones 708, 710 that may be defined/adjusted based on whether the robot is stationary (v = 0) or moving (v > 0). A stationary robot could more readily move in the reverse direction, for example. As a result, the robot may consider human presence to be unsafe in a larger area behind the robot than when the robot is moving in the forward direction. Also, depending on the robot’s forward speed, the robot may look further or less far ahead to detect human presence. If the robot is moving slowly, a human who is directly ahead of the robot but at a great distance may not be in danger. By contrast, if the robot travels at high speed, humans even at a considerable distance could be at risk.

Note that the safety zones in FIG. 7 include circular areas at the front end of the robot, to account for the range of motion of the robotic arms R1 and R2 at the front of the robot.

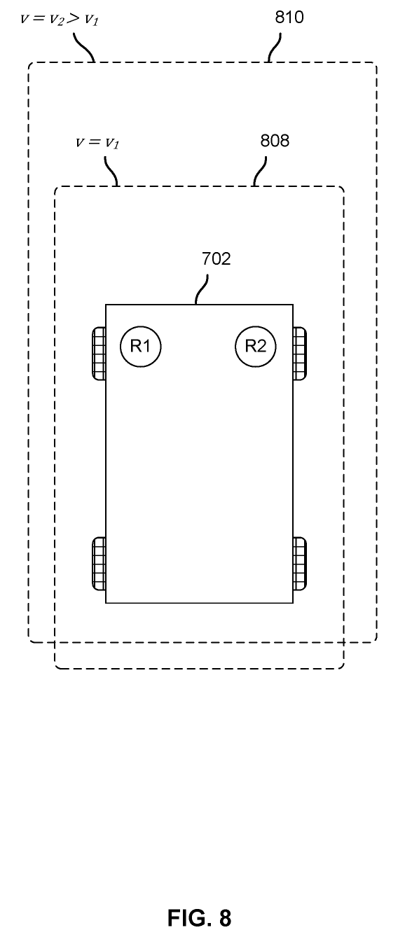

FIG. 8 illustrates an embodiment equipped with a functional safety system as disclosed herein. In FIG. 8, the same robot 702 is shown but we imagine its robotic arms R1 and R2 have been stowed in a position with all joints and links inboard of the outer edge of the chassis. In this example, the safety areas 808, 810 do not need to account for movement of the robotic arms and therefore the safety zones are rectangular. In this example, at the higher speed the safety zone is wider, extends further forward, and extends less far behind the robot.

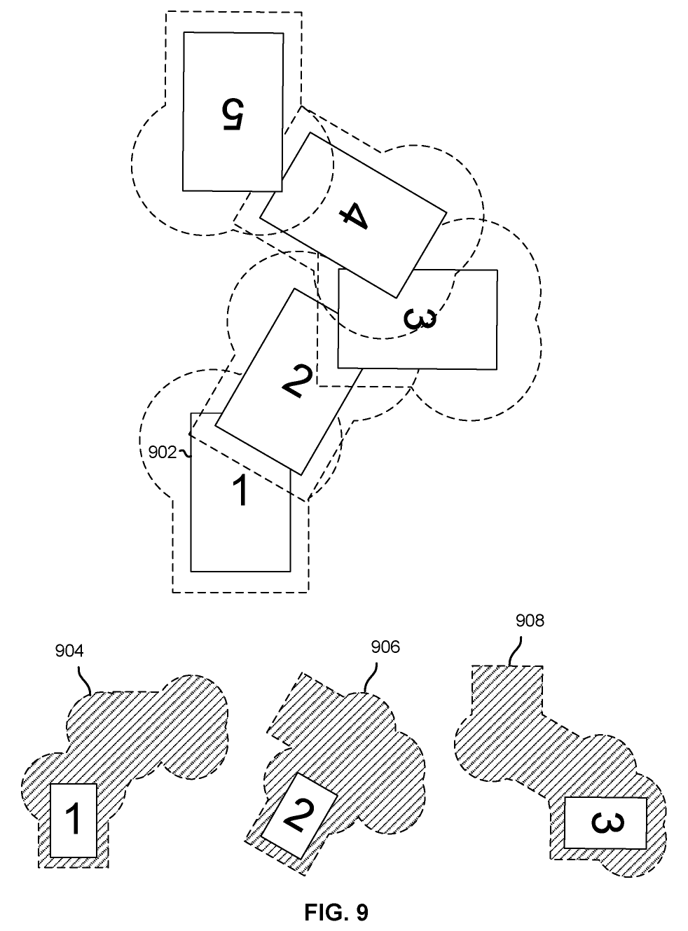

FIG. 9 illustrates an embodiment equipped with a functional safety system as disclosed herein. The example shown in FIG. 9 illustrates how the safety zone may be changed, dynamically, with time. In the example shown, the robot 902 makes something of a three-point turn, starting at position “1” and transitioning through positions “2”, “3”, “4”, and “5”. The images at bottom show the changing safety zone while in each of the first three positions. At left, when the robot is in position “1”, the safety zone 904 includes an area defined by positions “1”, “2”, and “3”, i.e., the current position and the next two positions into which the robot anticipates moving (next). A human located in any of part of the area shown may be at risk. In the middle image, the robot has moved into position “2” and looks ahead to the next two planned positions, “3” and “4”, to define the safety zone 906. Finally, as shown at right, the robot has moved into position “3” and looks ahead to the next two planned positions, “4” and “5”, to define the safety zone 908. In various embodiments, a human intersecting the safety zone as in effect at the time, or anticipated future time, may trigger an adaptive and/or responsive behavior, as disclosed herein.

In the example shown in FIG. 9, the functional safety system looks ahead to the next two positions to define the safety zone. In other circumstances, the system may look further or less far ahead, e.g., depending on how quickly the robot is moving or planning to move, how much danger the work currently being performed is considered to pose to humans, how fragile or dangerous to humans the material currently being handled is, etc.

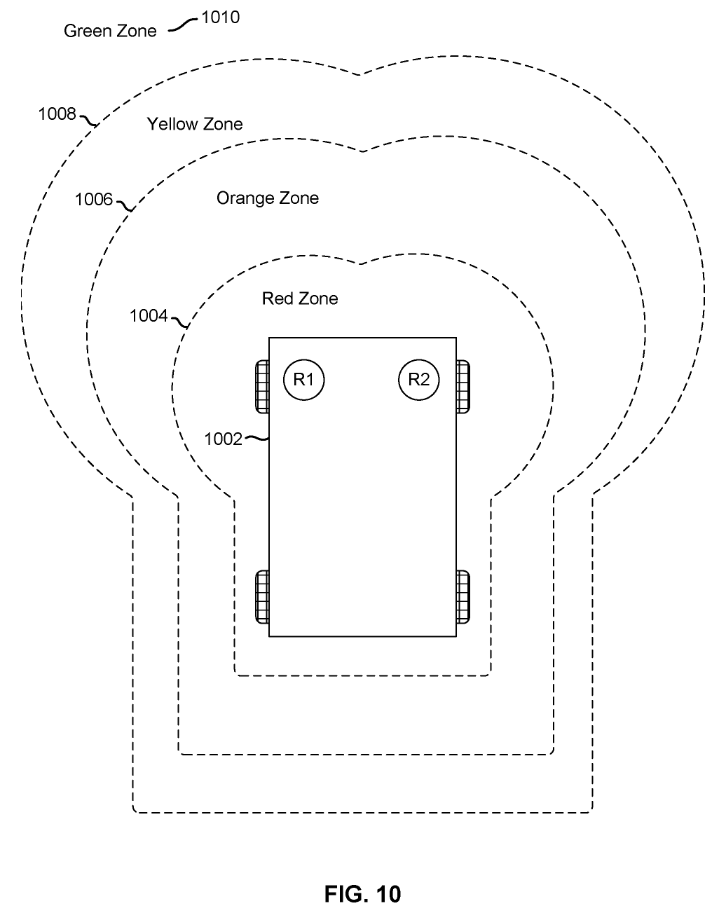

FIG. 10 illustrates an embodiment equipped with a functional safety system as disclosed herein. The example shown in FIG. 10, the functional safety system defines multiple zones 1004, 1006, 1008, 1010, each of which has a corresponding level of response to a human being present within that zone. For example, a human in the green zone 1010 may be ignored, while one in the yellow 1008 zone may be tracked closely, a human entering the orange zone 1006 may cause robot 1002 to adapt, such as by slowing down, and finally a human in the red zone 1004 may trigger an emergency stop. Other levels and/or responses may be defined. As described above, the shape and/or size of the safety zones may also be adjusted dynamically, e.g., as robot 1002 changes speed. In various embodiments, adapting speed of operation downward and/or otherwise adapting robot behavior as a human enters zones successively nearer the robot may avoid having to fully emergency stop the robot, e.g., if the human doesn’t approach so near that an emergency stop is required, or enable a stop to performed quickly and in a controlled manner, if needed, since the speed has been reduced as the human approached.

In some embodiments, a voice or other warning may be communicated, for example to warn the human not to approach more closely. Such a warning may enable the system to avoid slowing or stopping the robot to ensure human safety.

In various embodiments, a system as disclosed herein ensures compliance with applicable safety regulations. For example, the system may adapt a robot’s behavior dynamically, as disclosed herein, all while ensuring that applicable safety regulations are met. For example, as a human approaches, a robot may slow down to a speed that is less than or equal to a maximum speed at which the robot is permitted to operate, per safety regulations, best practices, etc., when a human is at the currently observed distance.

A functional robotic safety system has been disclosed. In various embodiments, techniques disclosed herein may be used to enable an autonomous robot to adapt its behavior and safety system dynamically, based on what the robot is doing, the context in which the robot is working, and detected conditions, to ensure human safety in a dynamic and unstructured environment.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic safety system, comprising:
a communication interface configured to receive sensor data from one or more sensors; and
a processor coupled to the communication interface and configured to:
use the sensor data to detect, in or near a workspace in which a robot with which the robotic safety system is associated is located, an actor or instrumentality that poses a potential safety risk to one or both of the robot and the detected actor or instrumentality; and
adapt a safety posture of the robotic safety system with respect to the robot to an extent needed to ensure the continued safety of both the robot and the detected actor or instrumentality;
wherein the adapted safety posture takes into account one or more of a task of the robot and a position and velocity of the actor or instrumentality relative to the robot.

2. The system of claim 1, wherein the processor is mounted on or in the robot.

3. The system of claim 1, wherein the sensor is mounted on the robot.

4. The system of claim 1, wherein the sensor is mounted in the workspace and the processor is further configured to translate the sensor data to a frame of reference of the robot.

5. The system of claim 1, wherein the actor or instrumentality comprises one or more of a human, another robot, a mobile robot, and a non-robotic equipment.

6. The system of claim 1, wherein the task comprises one or more of the following: pick and place an item, stack items in or on a receptacle, load items into a truck or other container, unload items from a truck or other container, and transit from a starting location to a destination location.

7. The system of claim 1, wherein the task comprises transiting from a starting location to a destination location and the safety posture includes a safety zone having a shape, size, and position relative to the robot that is determined based at least in part on a velocity of the robot.

8. The system of claim 1, wherein the adapted safety posture allows the robot to continue to move at a maximum speed but restricts movement of a robotic arm to keep a set of links and joints comprising the robotic arm within a confined space relative to a mobile chassis of the robot.

9. The system of claim 1, wherein adapted safety posture includes an audible, visual, or otherwise perceptible expression of one or more of the following: a warning or indication the robot is present; an indication of a safety risk posed by the robot; an indication of a risk of damage to the robot; an instruction to the actor or instrumentality to regulate its behavior to ensure safety.

10. The system of claim 1, wherein the adapted safety posture includes restricted movement of one or more elements comprising a robotic arm of the robot.

11. The system of claim 10, wherein restricting the movement comprises preventing said one or more elements comprising the robotic arm from entering a region of three-dimensional space otherwise reachable by said one or more elements comprising the robotic arm.

12. The system of claim 10, wherein restricting the movement comprises limiting said one or more elements comprising the robotic arm to operating at slower than a maximum speed of said one or more elements comprising the robotic arm.

13. The system of claim 10, wherein restricting the movement comprises changing how said one or more elements comprising the robotic arm respond to encounter an external force or obstacle.

14. The system of claim 1, wherein the sensor comprises a camera or other image sensor and the processor is configured to use a non-image sensor to detect that a threat may be present or approaching beyond a wall or other obstacle.

15. The system of claim 14, wherein the non-vision sensors comprises an audio sensor or an obstacle penetrating radar or sonar sensor.

16. The system of claim 1, wherein the processor is configured to not adapt the safety posture based on a determination that all sensors comprising a set of sensors that includes the sensor are operational and no sensor in the set of sensors includes sensor data indicating the presence of a human.

17. The system of claim 1, wherein the safety posture of the robot is adapted at least in part on which of a plurality of safety zones the detected actor or instrumentality is determined to be located within.

18. A robotic safety method, comprising:
receiving sensor data from one or more sensors;
using the sensor data to detect, in or near a workspace in which a robot with which the robotic safety system is associated is located, an actor or instrumentality that poses a potential safety risk to one or both of the robot and the detected actor or instrumentality; and
adapting a safety posture of the robotic safety system with respect to the robot to an extent needed to ensure the continued safety of both the robot and the detected actor or instrumentality;
wherein the adapted safety posture takes into account one or more of a task of the robot and a position and velocity of the actor or instrumentality relative to the robot.

19. The robotic safety method of claim 18, wherein the adapted safety posture includes restricted movement of one or more elements comprising a robotic arm of the robot.

20. A computer program product to provide robotic safety, the computer program product being embodied in a non-transitory computer readable medium and comprising computer instructions for:
receiving sensor data from one or more sensors;
using the sensor data to detect, in or near a workspace in which a robot with which the robotic safety system is associated is located, an actor or instrumentality that poses a potential safety risk to one or both of the robot and the detected actor or instrumentality; and
adapting a safety posture of the robotic safety system with respect to the robot to an extent needed to ensure the continued safety of both the robot and the detected actor or instrumentality;
wherein the adapted safety posture takes into account one or more of a task of the robot and a position and velocity of the actor or instrumentality relative to the robot.
